(19) United States
(12) Patent Application Publication
(10) Pub. No.: US 2018/0292561 A1
(43) Pub. Date: Oct. 11, 2018

(54) CROSSWELL TOMOGRAPHY USING AN ARRAY OF OPTICAL FIBER TRANSDUCERS

(71) Applicant: Halliburton Energy Services, Inc., Houston, TX (US)

(72) Inventors: Glenn Andrew Wilson, Houston, TX (US); Burkay Donderici, Houston, TX (US)

(73) Assignee: Halliburton Energy Services, Inc., Houston, TX (US)

(21) Appl. No.: 15/770,992

(22) PCT Filed: Dec. 3, 2015
(86) PCT No.: PCT/US2015/063755

§ 371 Date: Apr. 25, 2018

(51) Int. Cl. G01V 3/30; G01V 3/26; G01V 8/24; G01V 1/52; G01V 3/34; E21B 47/12

(52) U.S. Cl. CPC G01V 3/30; G01V 3/26; E21B 47/123; G01V 1/52; G01V 3/34; G01V 8/24

(57) ABSTRACT

A system includes an electromagnetic transmitter disposed in a first borehole. The system further includes an optical fiber disposed in a second borehole. The system further includes an array of electromagnetic transducers coupled to the optical fiber in the second borehole. The transducers are able to operate simultaneously with each other. The system further includes one or more processors to generate a tomographic image of at least a partial formation between the first and second borehole based on measurements of tomography signals, transmitted by the electromagnetic transmitter, collected by the array.

### BACKGROUND

Modern oil and gas operations demand a great quantity of information relating to the parameters and conditions encountered downhole. Among the types of desired information is the extent and distribution of fluids in the reservoir formations. While it is possible to glean a general picture of such fluids with surface surveys, the surveys are limited by the effects of the subsurface layers overlying the region of interest. Such effects can be eliminated or reduced by the use of multiple boreholes in or near the region of interest. With a suitable arrangement of a transmitter in one borehole and receiver in another borehole, crosswell tomography can be used to extract a comparatively detailed image of the region of interest, suitable for planning and monitoring production from a reservoir.

Initially, crosswell tomography was performed using seismic transmitters and receivers, but more recently the focus has been on the use of electromagnetic transmitters and receivers. As with any geophysical survey, noise and inaccuracies in the survey system will negatively impact image quality. Additionally, capturing the data for crosswell tomography is a time-intensive process. Specifically, the transmitter is run downhole and pulled uphole for a receiver position, the receiver position is changed, the transmitter is run downhole and pulled uphole for the new receiver position, and so on for each desired receiver position. Thus, there exists a tradeoff between the amount of data captured (and hence the quality of the final result) and time.

### BRIEF DESCRIPTION OF THE DRAWINGS

Accordingly, systems and methods of crosswell tomography using an array of optical fiber transducers are disclosed herein. In the following detailed description of the various disclosed embodiments, reference will be made to the accompanying drawings in which:

FIG. 1 is a contextual view of an illustrative wireline environment;

FIGS. 2A-2C are sequence diagrams of an illustrative configuration of transmitter and receiver positions for crosswell tomography;

FIG. 3 is an isometric diagram of an illustrative configuration of a transmitter borehole and multiple receiver boreholes;

FIGS. 4A and 4B are schematic diagrams showing an illustrative configuration of optical fibers;

FIG. 5 is diagram of an illustrative transmitter, within a borehole, including a magnetic multi-turn loop antenna;

FIG. 6 is diagram of illustrative transmitters, within a borehole, and multiple magnetic multi-turn loop antennas;

FIG. 7 is a diagram of an illustrative wireless communication network between transmitter and receiver boreholes;

FIG. 8 is a diagram of an illustrative configuration of a lateral transmitter borehole and multiple lateral receiver boreholes; and

FIG. 9 is a flow diagram of an illustrative method of crosswell tomography using an array of optical fiber transducers.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical or physical connection. Thus, if a first device couples to a second device, that connection may be through a direct electrical connection, through an indirect electrical connection via other devices and connections, through a direct physical connection, or through an indirect physical connection via other devices and connections in various embodiments.

### DETAILED DESCRIPTION

The issues identified in the background are at least partly addressed by systems and methods of crosswell tomography using an array of fiber optic transducers. When a transmitter is deployed in a transmitter borehole and arrays of fiber optic transducers are deployed in receiver boreholes, there is no tradeoff between the amount of data captured (and hence the quality of the final result) and time. Specifically, all the data is captured in one run of the transmitter up and down the borehole for any amount of receiver positions or number of boreholes. Additionally, the entire single run of the transmitter may not be necessary in various embodiments. For example, all the data may be captured as the transmitter descends the borehole, or all the data may be captured as the transmitter ascends the borehole.

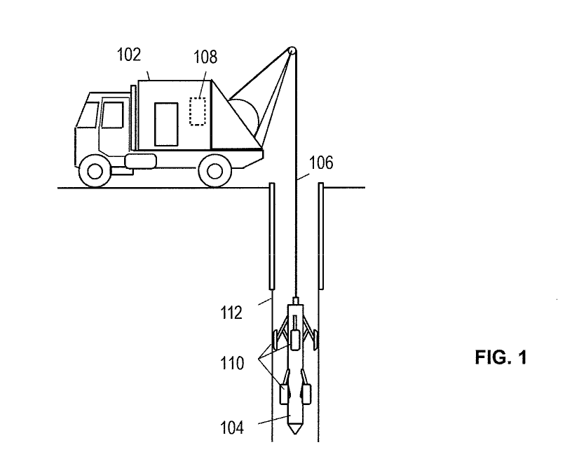

FIG. 1 is a contextual view of an illustrative wireline transmitter embodiment. A transmitter truck 102 may suspend a wireline transmitter tool 104 on a wireline cable 106 having conductors for transporting power to the tool 104 and telemetry from the tool 104 to the surface. The tool 104 may include an antenna or one or more electrodes 110 for transmitting crosswell tomography signals. On the surface, a computer 108 obtains and stores data from the tool 104 as a function of axial position along the borehole 112 and optionally as a function of azimuth. Though shown as an integrated part of the transmitter truck 102, the computer 108 can take different forms including a tablet computer, laptop computer, desktop computer, and virtual cloud computer, and executes software to carry out necessary processing and enable a user to view and interact with a display of the resulting information. Specifically, a processor coupled to memory may execute the software. In some cases, the processor need not be coupled to memory. For example, the processor may use registers or logic to store data or the software may be written such that access to memory is not necessary. The software may collect the data and organize it in a file or database. The software may respond to user input via a keyboard or other input mechanism to display data as an image or movie on a monitor or other output mechanism such as a printer. Also, the software may process the data to optimize crosswell tomography as described below. In this way, a multi-dimensional representation of the surrounding formation may be obtained, processed, and displayed. Furthermore, the software may issue an audio or visual alert to direct the user's attention to a particular location, result, or piece of data. Also, the processor may perform any appropriate step described below. In at least one embodiment, the tool 104 itself may include a processor coupled with memory to obtain, store, and process data downhole. In another embodiment, processors both at the surface and downhole may work together or independently to obtain, store, and process measurement data.

In general, optical sensors may be used downhole. For example, to perform cross-well telemetry operations, the electromagnetic (“EM”) transmitter emits an EM field that is modulated to convey a data stream. Various modulation techniques are possible (e.g., amplitude modulation, frequency modulation, phase modulation, pulse modulation). The data stream may correspond to raw sensor data, processed data, compressed data, or a combination of different types of data. The EM field is sensed by one or more fiber optic sensors that are part of an array of such sensors deployed in a borehole. The borehole may correspond to a completed well with casing that has been cemented in place. In such case, the fiber optic sensors may be permanently deployed as part of the well completion process for borehole. For example, each fiber optic sensor may be attached to the exterior of a casing segment by one or more bands or other attachment mechanism. Once the casing is cemented in place, the fiber optic sensors and the fiber optic cable will likewise be cemented in place and will enable ongoing sensing and cross-well telemetry operations. Alternatively, the borehole may correspond to an open well or partially completed well. In such case, the fiber optic sensors may be deployed along an open section in the borehole using wireline and/or pump down operations.

The EM field measurements may be collected by one or more sensors in the array are conveyed to earth's surface via the fiber optic cable, which includes one or more optical fibers. In operation, the fiber optic sensors generate light in response to an EM field or modulate the intensity or phase of interrogation (source) light in response to an EM field. The generated or modulated light from a given fiber optic sensor provides information regarding the modulated EM field sensed by that given sensor. As desired, time division multiplexing (TDM), wavelength division multiplexing (WDM), mode-division multiplexing (MDM) and/or other multiplexing options may be used to recover the measurements associated with each fiber optic sensor deployed along fiber optic cable.

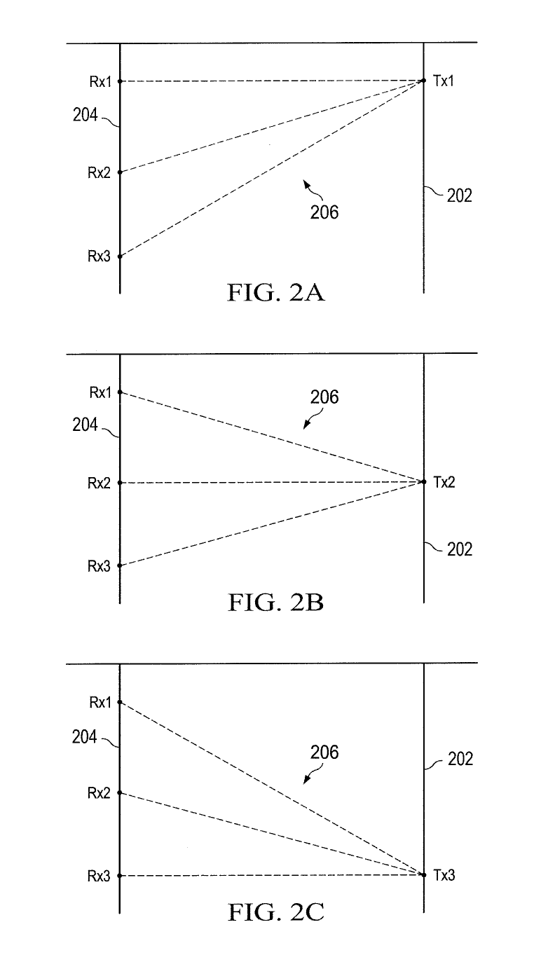

FIGS. 2A-2C are sequence diagrams of an illustrative configuration of transmitter and receiver positions. Specifically, FIGS. 2A-2C illustrate a transmitter borehole 202, a receiver borehole 204, and tomography signals transmitted by a transmitter in the transmitter borehole 202 and received by an array of fiber optic transducers coupled to a fiber optic cable in the receiver borehole 204. One transducer is at each of the positions Rx1, Rx2, and Rx3. A transducer converts variations in a physical quantity into an electrical signal or vice versa. At FIG. 2A, the transmitter is at position Tx1 in the transmitter borehole 202. Tomography signals 206 are output by the transmitter, and the signals 206 are received by the transducers at each receiver position Rx1, Rx2, Rx3. At FIG. 2B, the transmitter is moved to position Tx2, tomography signals 206 are output by the transmitter, and the signals 206 are received by the transducers at each receiver position Rx1, Rx2, Rx3. At FIG. 2C, the transmitter is moved to position Tx3, tomography signals 206 are output by the transmitter, and the signals are received by the transducers at each receiver position Rx1, Rx2, Rx3. While the sequence of FIGS. 2A-2C illustrate the transmitter traveling downhole, the same set of tomography signals may be sent and received while the transmitter is traveling uphole, or both downhole and uphole, as desired. In either case, only one run of the transmitter up and down the transmitter borehole 202 is performed.

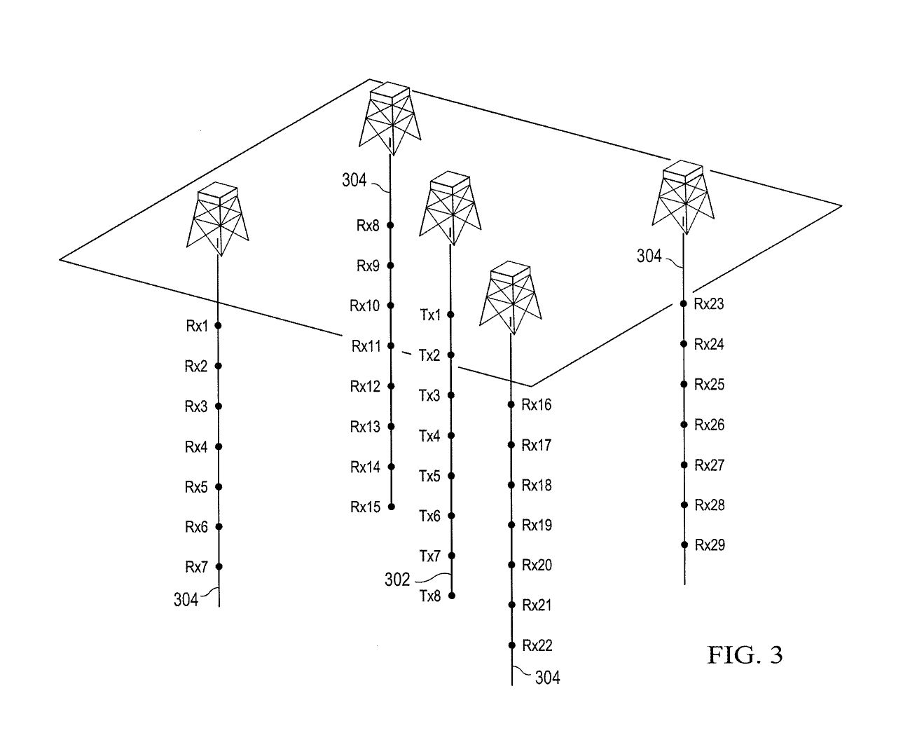

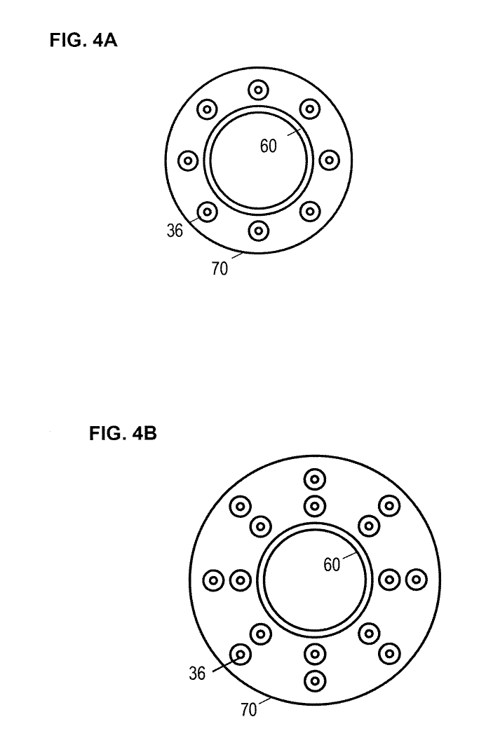

FIG. 3 is an isometric diagram of an illustrative configuration of a transmitter borehole 302 and multiple receiver boreholes 304. Despite the receiver boreholes 304 being located at different azimuths from the transmitter borehole 302, only one run of the transmitter up and down the borehole 302 is performed because the tomography signals are sent in each azimuthal direction or all azimuthal directions as desired. The transmitter outputs tomography signals at eight positions: Tx1, Tx2, . . . , and Tx8. Each receiver borehole 304 includes a transducers coupled to an optical fiber at multiple positions along the fiber. In total, there are twenty-nine receiver positions among all the receiver boreholes 304: Rx1, Rx2, . . . , and Rx29. Each receiver position may be at any depth or position along the receiver boreholes 304 relative to the other receiver positions. Only one run of the transmitter up and down the transmitter borehole 302 is necessary because all twenty-nine transducers may operate simultaneously. The tomography signals may be sent while the transmitter is traveling downhole, uphole, or both as desired. The optical fibers may be deployed in open boreholes, or may be deployed within cased boreholes as shown in FIGS. 4A and 4B.

FIGS. 4A and 4B are schematic diagrams showing an illustrative configuration of optical fibers in cross section. At FIG. 4A, multiple fiber optic cables 36 are distributed in the annular space between the casing 60 and a borehole wall 70. At FIG. 4B, the fiber optic cables 36 have a distribution with axial, azimuthal, and radial variation. The annular space between the casing 60 and the borehole wall 70 may be filled with cement for a more permanent installation.

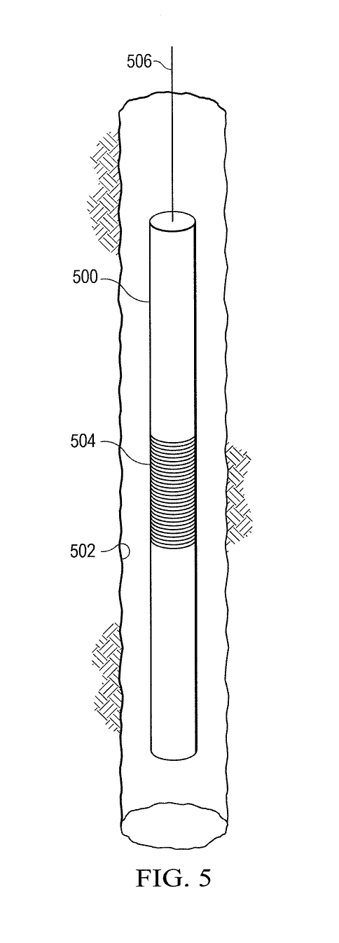

FIG. 5 is diagram of an illustrative transmitter 500, within a borehole 502, including a magnetic multi-turn loop antenna 504 and supported by a wireline 506. Such an antenna 504 may be deployed in a fluid-filled open borehole, a fluid-filled cased borehole, and the like. The antenna 504 may have a magnetic (e.g., ferrite) core or a non-magnetic core. The antenna 504 may be tilted at an angle with respect to the axis of the transmitter 500 to produce a directional sensitivity to the formation. The transmitter 500 may operate at different positions along the borehole 502, and the transmitter 500 may be powered by batteries, fuel cells, or have power delivered from the wireline 506. The transmitter 500 may be axially oriented along the borehole 502 as shown or may be tilted relative to the longitudinal axis of the borehole 502.

The transmitter 500 may include at least one electrode pad that may be pushed against the borehole 502 wall for galvanic coupling, and if so, a counter electrode may be located at the surface so the system emulates an electric monopole source. If two or more electrode pads are used, the system emulates an electric bipole source. The electrodes may include an electrically conductive, corrosion resistant, low potential material (e.g., stainless steel). Also, the electrodes may be capacitive electrodes. Capacitive electrodes may operate in highly resistive oil-based muds or highly conductive water-based muds, and capacitive electrodes do not require contact with the formation.

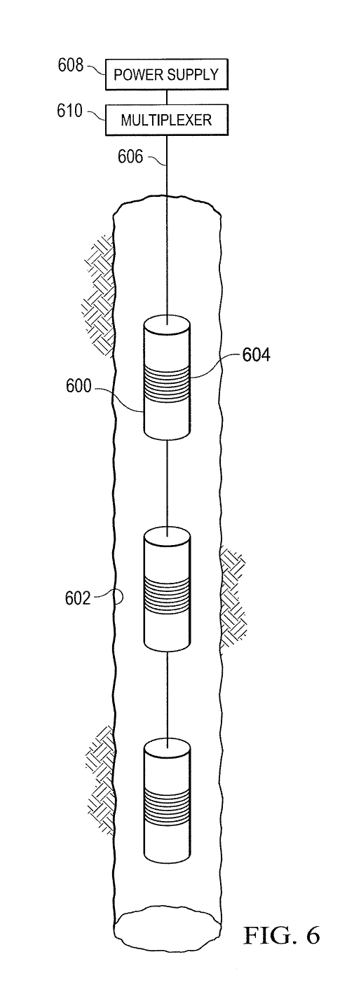

FIG. 6 is diagram of multiple transmitters 600 supported by a wireline 606, within a borehole 602, and multiple magnetic multi-turn loop antennas 604. Power may be delivered from a power supply 608 to one or more transmitters 600, as selected by a multiplexer 610, via the wireline 606. The multiplexer 610 may include circuitry to select a particular transmitter 600 to operate based on a selection algorithm, which may be updated in real time. By using multiple transmitters, even more data may be captured in the same amount of time or less.

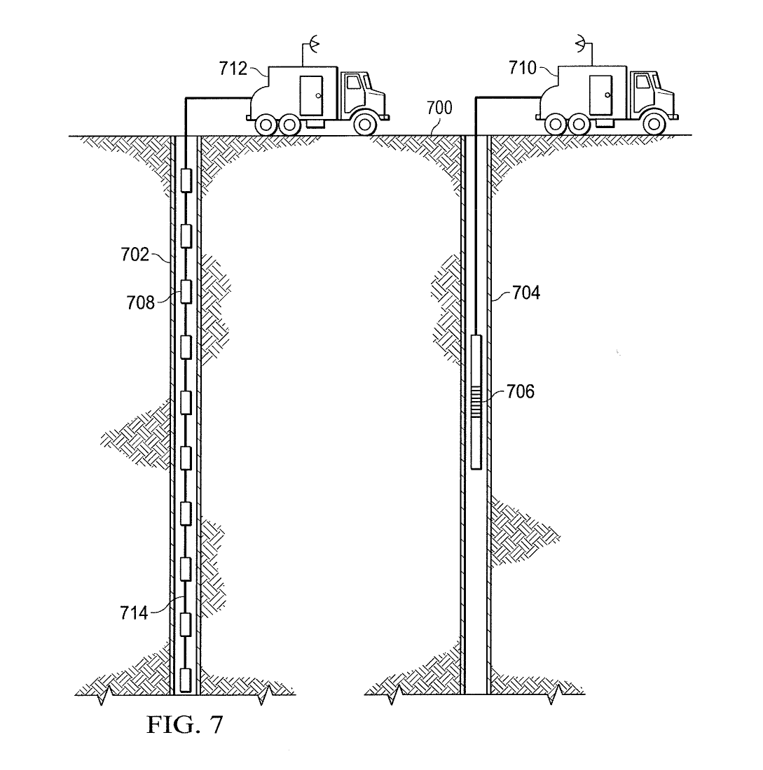

FIG. 7 is a diagram of an illustrative wireless communication network 700 between a transmitter borehole 704 and a receiver borehole 702. The transmitter borehole 704 may contain a transmitter 706 supported by a wireline attached to a transmitter truck 710 at the surface. The receiver borehole 702 may contain an array 708 of transducers coupled to an optical fiber 714, or fiber-optic cable, attached to a receiver truck 712 at the surface. The network 700 may enable communication between one or more processors in the receiver truck 712 coupled to the array 708 and one or more processors in the transmitter truck 710 coupled to the transmitter 706. The communication may be used to temporally synchronize the transmitter 706 and the array 708. For example, the phase of the transmitted signals may be correlated with the phase of the received signal. In this way, noise may be reduced or eliminated, and the signal-to-noise ratio may be improved. As desired, time division multiplexing, wavelength division multiplexing, mode-division multiplexing and/or other multiplexing options may be used for transmission.

Transducers are located at different positions along the receiver borehole 702, and are able to operate simultaneously with each other. The transducers may include a piezoelectric component, a hinged reflective surface, an optical resonator, and the like. The fiber 714 may be a strain-sensing optical fiber, and the transducers may be a magnetostrictive material or electrostrictive material. For example, the material may directly strain or otherwise change the condition of the optical fiber in the presence of tomography signals transmitted by the transmitter 706 through the formation. A magnetostrictive material may include cobalt, nickel, and iron metals, and their alloys, e.g., Metglass and Terfenol-D. An electrostrictive material may include lithium niobate and lead zirconate titanate. Deformation of the magnetostrictive or electrostrictive component may cause a corresponding strain in the optical fiber, and a source light beam in the optical fiber may be proportionally modulated by the strain. The optical fiber may be interrogated by strain measurement methods including interferometric, fiber Bragg grating, fiber laser strain, and extrinsic Fabry-Perot interferometric methods.

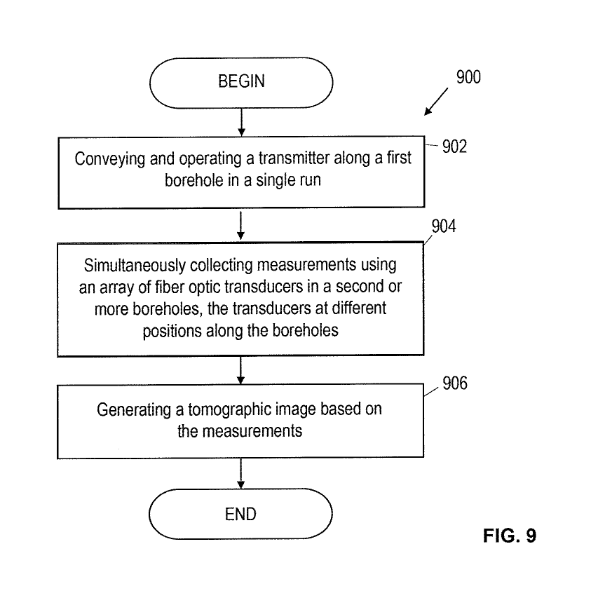

The receiver truck 712 or transmitter truck 710 may include one or more processors to perform various operations such as converting received signals from one format to another, demodulating crosswell tomography data, storing crosswell tomography data, processing crosswell tomography data, deriving logs from the crosswell tomography data, and/or displaying visualizations related to the crosswell tomography data as discussed with respect to FIG. 9. For example, the one or more processors may generate a tomographic image based on measurements collected by the array 708 in the receiver borehole 702.

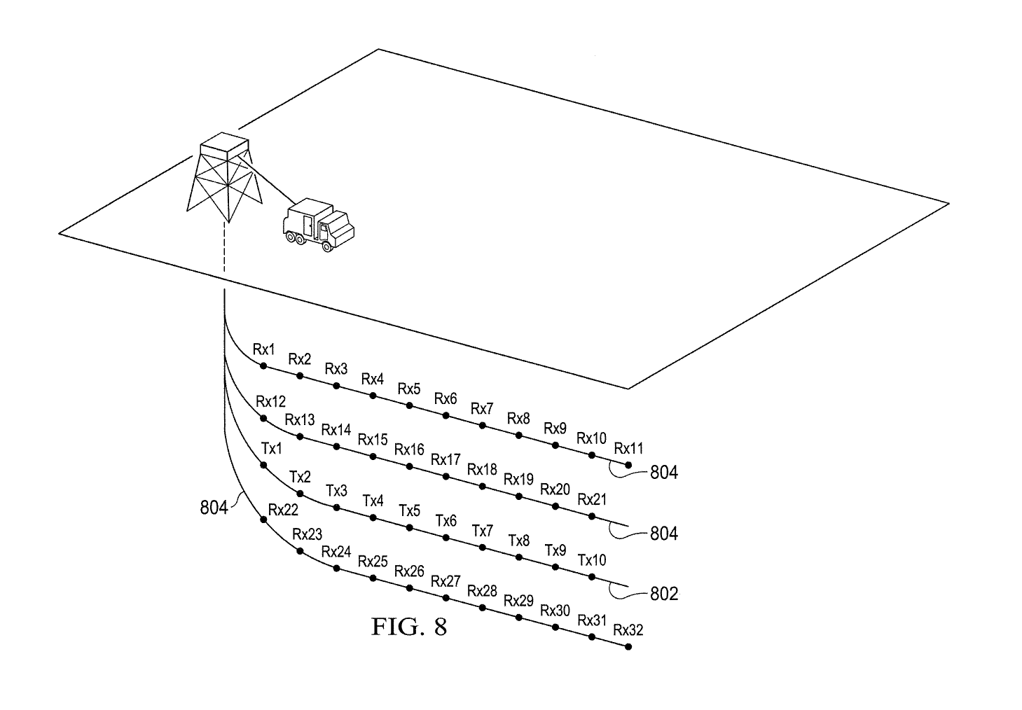

FIG. 8 is a diagram of an illustrative configuration of a lateral transmitter borehole 802 and multiple lateral receiver boreholes 804. Such a configuration is similar to that of FIG. 3 except the direction of the boreholes is lateral and the upper portions of each borehole are coupled. The transmitter outputs tomography signals at ten positions: Tx1, Tx2, . . . , and Tx10. Each receiver borehole 804 includes transducers coupled to an optical fiber at multiple positions along the fiber. In total, there are thirty-two receiver positions among all the receiver boreholes 804: Rx1, Rx2, . . . , and Rx32. Each receiver position may be at any position along the receiver boreholes 804 relative to the other receiver positions. Only one run of the transmitter up and down the transmitter borehole 802 is necessary because all thirty-two transducers may operate simultaneously. The tomography signals may be sent while the transmitter is traveling downhole, uphole, or both as desired.

FIG. 9 is a flow diagram of an illustrative method of crosswell tomography. At 904, a transmitter is conveyed along a first borehole. The transmitter may operate at different positions along the first borehole, and the transmitter may include at least one electrode. The transmitter may include a magnetic-core multi-turn loop antenna or an array of magnetic-core multi-turn loop antennas to transmit tomography signals through a formation at each position. Conveying the transmitter may include performing only one run of the transmitter prior to generating the tomographic image.

At 906, measurements are collected using an array of fiber optic transducers coupled to an optical fiber or fiber optic cable in a second borehole. Specifically, the transducers receive the tomography signals transmitted by the transmitter. The transducers are at different positions along the second borehole, and are able to operate simultaneously with each other. The fiber may include a strain-sensing optical fiber, and the transducers may be a magnetostrictive material or electrostrictive material. Accordingly, the transducers may induce a strain in the optical fiber in response to receiving the tomography signals.

A wireless communication network may enable communication between one or more processors coupled to the array and one or more processors coupled to the transmitter. The communication may be used to temporally synchronize the transmitter and the array. In this way, noise may be reduced or eliminated, and the signal-to-noise ratio may be improved.

A second array of transducers may be coupled to an optical fiber in a third borehole. The transducers of the second array may be at different positions along the third borehole, may operate simultaneously with each other, and may operate simultaneously with the transducers of the array as the transmitter operates at different positions along the first borehole.

At 908, a tomographic image of the formation between the boreholes is generated based on the measurements. Generally, tomographic processing creates a map of resistivity of the area between the wells. Measurements acquired by this technique have a greater depth of investigation than conventional logging tools and are sensitive to fluid content. The tomographic images are used for monitoring sweep efficiency, identifying bypassed pay, planning infill drilling locations, and improving the effectiveness of reservoir simulations.

The tomographic image may be generated based on measurements collected by the array and the second array. First, the received tomography signals may be demodulated. As an example, in order to recover a data stream of 1000 bits/second, it should be appreciated that the sampling rate for the measurements collected by transducers must be at least 1000 bits/second. Further, knowledge regarding the particular modulation scheme being used may be used for demodulation. For example, time division multiplexing, wavelength division multiplexing, mode-division multiplexing, and/or other multiplexing options may be used. Demodulation may also be facilitated by knowing the position of the transmitter relative to one or more of the transducers. Further, the orientation of the transmitter and/or the orientation of the transducers may be selected so as to increase the signal-to-noise ratio and/or range of tomography. In at least one embodiment, the transmitter transmits in all azimuthal directions.

Next, an inversion process may be performed. The inversion algorithm may be based on deterministic and/or stochastic methods of optimization. In at least some embodiments, a formation model is used for the inversion algorithm. This model may be constructed a priori from seismic data and/or resistivity data, and can be single or multi-dimensional. To construct a model, computational algorithms for accurate model constructions may be employed using the seismic and resistivity logs for initial parameters. Next, an iterative inversion process adapts the model of the region of interest until the model data are matched by predicted data. The model is recalculated until the error between the predicted and model data values falls below a threshold. The model, including any tomographic images, is then output for visualization and/or analysis to determine the amount and distribution of fluids in the reservoir.

As described, this disclosure does not require the transmitter be run in and out of the well for every receiver position. Rather, data for all receiver positions is acquired simultaneously for a given transmitter position. As such, the time required to access the boreholes is significantly decreased. Additionally, the use of optical fibers obviate the need for power and electronic components to be deployed downhole.

In at least one embodiment, a system includes an electromagnetic transmitter in a first borehole. The system further includes an optical fiber in a second borehole. The system further includes an array of electromagnetic transducers coupled to the fiber in the second borehole. The transducers are able to operate simultaneously with each other. The system further includes one or more processors to generate a tomographic image of at least a partial formation between the first and second boreholes based on measurements of tomography signals, transmitted by the electromagnetic transmitter, collected by the array.

In another embodiment, a method includes conveying an electromagnetic transmitter along a first borehole. The transmitter operates at different axial positions along the first borehole. The method further includes collecting measurements of tomography signals, transmitted by the electromagnetic transmitter, using an array of electromagnetic fiber optic transducers in a second borehole. The transducers are able to operate simultaneously with each other. The method further includes generating a tomographic image of the formation between the first and second boreholes based on the measurements.

The following features may be incorporated into the various embodiments. The transmitter may operate at different axial positions along the first borehole. A second array of electromagnetic transducers may be coupled to an optical fiber in a third borehole. The transducers of the second array may be at different positions along the third borehole, may operate simultaneously with each other, and may operate simultaneously with the transducers of the array as the transmitter operates at different positions along the first borehole. The tomographic image may be generated based on measurements collected by the array and the second array. The transmitter may include at least one electrode. The transmitter may include a magnetic-core multi-turn loop antenna or an array of magnetic-core multi-turn loop antennas. A wireless communication network may enable communication between one or more processors coupled to the array and one or more processors coupled to the transmitter. The communication may be used to synchronize the transmitter and the array. The fiber may include a strain-sensing optical fiber coupled to a magnetostrictive material. The fiber may include a strain-sensing optical fiber coupled to an electrostrictive material. The transmitter and the array may be temporally synchronized. Conveying the transmitter may include performing only one run of the transmitter prior to generating the tomographic image.

Numerous variations and modifications will become apparent to those skilled in the art once the above disclosure is fully appreciated. The ensuing claims are intended to cover such variations where applicable.

What is claimed is:

1. A system for crosswell tomography comprising:
an electromagnetic transmitter disposed in a first borehole;
an optical fiber at least partially disposed in a second borehole;
an array of electromagnetic transducers, disposed in the second borehole, coupled to the optical fiber, each transducer in the array able to operate simultaneously with at least one other transducer in the array; and
one or more processors coupled to the array to generate a tomographic image of at least a partial formation between the first and second borehole based on measurements of tomography signals, transmitted by the electromagnetic transmitter, collected by the array.

2. The system of claim 1, wherein the transmitter operates at different positions along the first borehole and the tomographic image is generated based on the measurements of the tomography signals transmitted by the transmitter from the different positions.

3. The system of claim 1, further comprising a second array of electromagnetic transducers coupled to an optical fiber disposed in a third borehole, each transducer of the second array able to operate simultaneously with at least one other transducer in the second array and able to operate simultaneously with at least one transducer in the array as the transmitter operates at different axial positions along the first borehole.

4. The system of claim 3, wherein the one or more processors generate the tomographic image based on measurements of tomography signals, transmitted by the electromagnetic transmitter, collected by the array and the second array.

5. The system of claim 1, wherein the transmitter comprises at least one electrode.

6. The system of claim 1, wherein the transmitter comprises a magnetic-core multi-turn loop antenna.

7. The system of claim 1 wherein the transmitter comprises an array of magnetic-core multi-turn loop antennas.

8. The system of claim 1, further comprising a wireless communication network, wherein the wireless communication network enables communication between the one or more processors coupled to the array and one or more processors coupled to the transmitter.

9. The system of claim 8, wherein the communication is used to synchronize the transmitter and the array.

10. The system of claim 1, wherein the optical fiber comprises a strain-sensing optical fiber coupled to a magnetostrictive material.

11. The system of claim 1, wherein the optical fiber comprises a strain-sensing optical fiber coupled to an electrostrictive material.

12. A method of crosswell tomography comprising:
conveying an electromagnetic transmitter along a first borehole, the transmitter operating at different axial positions along the first borehole;
collecting measurements of tomography signals, transmitted by the electromagnetic transmitter, using an array of electromagnetic fiber optic transducers disposed in a second borehole, the transducers able to operate simultaneously with each other; and
generating a tomographic image of at least a partial formation between the first and second borehole based on the measurements.

13. The method of claim 12, wherein each of the transducers in the array are disposed at a different axial position along the second borehole.

14. The method of claim 12, further comprising collecting measurements using a second array of fiber optic transducers in a third borehole, each of the transducers in the second array disposed at different axial positions along the third borehole, able to operate simultaneously with each other, and able to operate simultaneously with the transducers of the array as the transmitter operates at different axial positions along the first borehole.

15. The method of claim 14, wherein generating the tomographic image comprises generating the tomographic image based on measurements of the tomography signals, transmitted by the electromagnetic transmitter, collected by the array and the second array.

16. The method of claim 12, further comprising temporally synchronizing the transmitter and the array.

17. The method of claim 12, wherein collecting the measurements comprises sensing strain using an optical fiber coupled to a magnetostrictive material.

18. The method of claim 12, wherein collecting the measurements comprises sensing strain using an optical fiber coupled to an electrostrictive material.

19. The method of claim 12, wherein conveying the transmitter comprises performing only one run of the transmitter prior to generating the tomographic image.

20. The method of claim 12, wherein conveying the transmitter comprises conveying a magnetic-core multi-turn loop antenna axially along the first borehole.
